(19) United States
(12) Patent Application Publication
(10) Pub. No.: US 2006/0083010 A1
(43) Pub. Date: Apr. 20, 2006

(54) Detachable lamp

(75) Inventor: Qiu Jian Ping, Hangzhou (CN)

Correspondence Address: WILLIAM COLLARD;COLLARD & ROE, P.C., 1077 NORTHERN BOULEVARD, ROSLYN, NY, 11576, US

(73) Assignee: Great Neck Saw Manufacturers, Inc.

(21) Appl. No.: 10/966,286

(22) Filed: Oct. 15, 2004

(51) Int. Cl. F21V 21/08; F21V 21/096; F21V 21/00

(52) U.S. Cl. 362/396; 362/398

(57) ABSTRACT

A detachable lamp for attachment to an article having an attachment assembly, a bulb assembly and connecting mechanism to connect the attachment assembly to the bulb assembly. The attachment assembly has a power assembly to provide electric power to the bulb assembly and a clamp assembly to permit attachment to an article.

### BACKGROUND

The present invention relates to a detachable lamp and more particularly to a detachable lamp which may be removably attached to an article, such as a shelf, table or barbeque grill.

Detachable lamps for detachable attachment to articles such as shelves, tables and barbeque grills have been in use for a number of years. Many of these lamps have complicated mechanisms for removably attaching them to an article. Some of them require special-tools for removably attaching them to an article. Some of these lamps do not have the versatility for attaching them to various types of articles, such as metal articles and non-metal articles.

### OBJECTS

The present invention overcomes these problems and has for one of its objects the provision of an improved detachable lamp which has improved means for removeably attaching it to an article.

Another object of the present invention is the provision of an improved detachable lamp which has versatile means for detachably attaching it to a variety of articles such as a shelf, table or barbeque grill.

Another object of the present invention is the provision of an improved detachable lamp which is simple to use and inexpensive to manufacture.

Other and further objects of the invention will be obvious upon an understanding of the illustrative embodiment about to described, or will be indicated in the appended claims and various advantages not referred to herein will occur to one skilled in the art upon employment of the invention in practice.

### DRAWINGS

FIG. 1 is a perspective view of a detachable lamp made in accordance with the present invention.

FIG. 2 is a sectional view taken along line 2-2 of FIG. 1.

FIG. 3 is a sectional view taken along line 3-3 of FIG. 1.

FIG. 4 is a side elevational view thereof showing one manner of attaching the detachable lamp to an article, such as a barbeque grill.

FIG. 5 is another perspective view showing another manner of attaching the detachable lamp to an article, such as a barbeque grill.

FIG. 6 is a side view, partly in section, showing another embodiment of the present invention.

### DESCRIPTION

For convenience, the detachable lamp of the present invention will be described in connection with its use on a barbeque grill. However, it will be understood that the detachable lamp of the present invention may be used with different articles, such as a table, shelf or some other article, without departing from the invention.

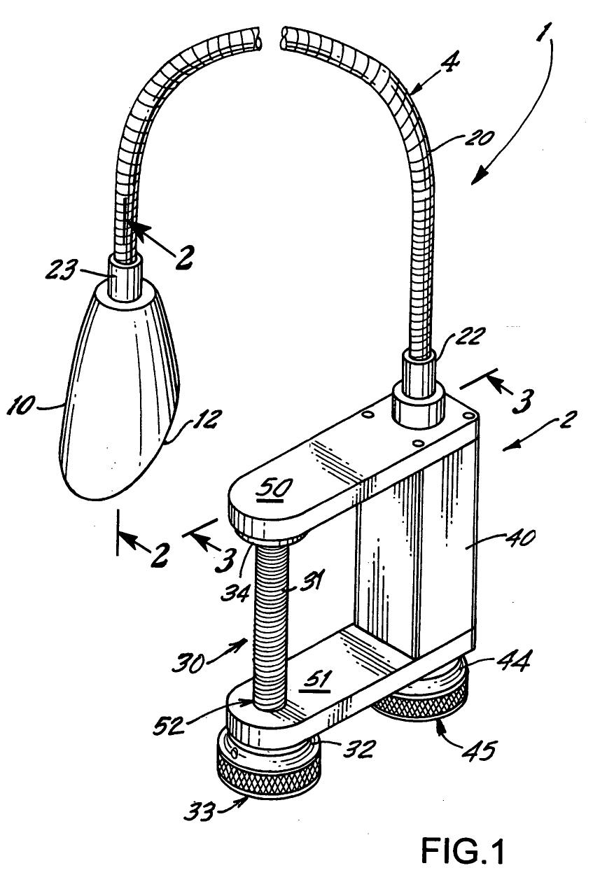

Referring to the drawings, and more particularly to the embodiment shown in FIGS. 1 to 5, the detachable lamp 1 of the present invention comprises an attachment assembly 2, a bulb assembly 3 and a connecting assembly 4 interposed between and connecting the attachment assembly 2 and bulb assembly 3 together.

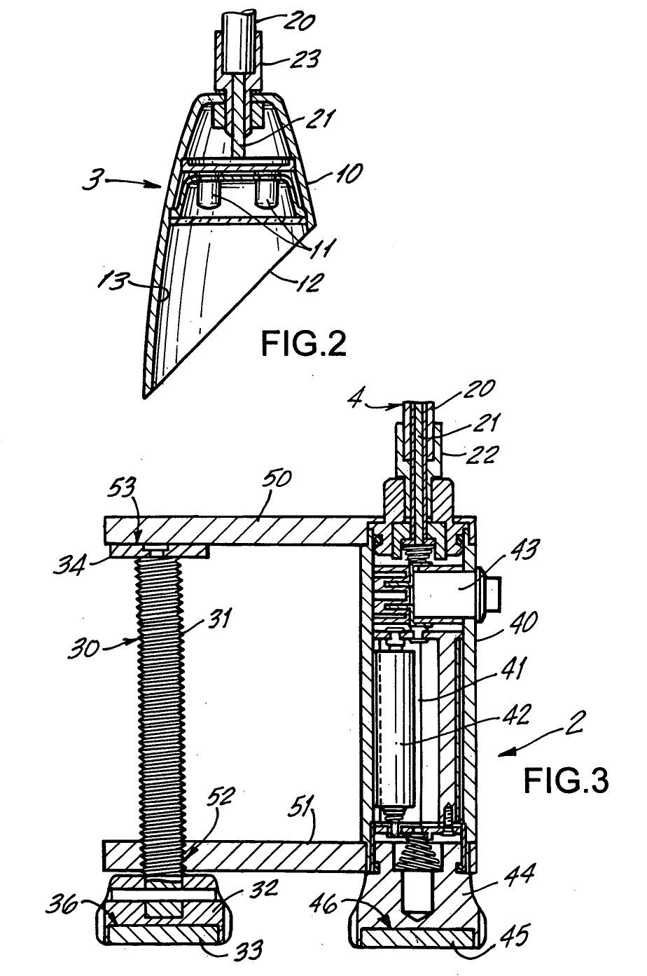

The bulb assembly 2 comprises a reflector hood 10 within which a pair of bulbs 11 are mounted (FIG. 2). It will be understood that while two bulbs 11 are shown in the drawings, any number of bulbs 11 may also be used without departing from the invention. The reflector hood 10 has a front opening 12 which is cut at an angle to the longitudinal axis of the hood 10 to permit more light to pass through the front opening 12 in the hood 10 and to permit the inner surface 13 of the reflector hood to reflect more light and allow more light to pass through the front opening 12.

The connecting assembly 4 comprises a flexible goose neck outer portion 20 having electrical conducting means therewithin, such as conducting wire 21, and a pair of connecting ends 22 and 23. One connecting end 23 (FIG. 2) is attached to the hood 13 and electrically connected to the bulb assembly 3 and the other connecting end 22 (FIG. 3) is attached to the attachment assembly 2 and is in electrical contact with battery means 42 in the attachment assembly 2.

The attachment assembly 2 (FIG. 3) comprises a clamp assembly 30, a power assembly 40 and a pair of horizontally spaced upper and lower arms 50 and 51, respectively, extending from the power assembly 40 and connecting the power assembly 40 to the clamp assembly 30.

The power assembly 40 comprises a battery holder 41 (FIG. 3) to receive one or more batteries 42 and an on/off switch 43 which may be of any well known construction. The on/off switch 43 has on/off connections to electrically connect and disconnect the conducting wire 21 and the batteries 42. It will be understood that other types of electrical switches 43 or battery holders 41 may be used without department from the invention. It will also be understood that the detachable lamp 1 may be electrically powered by other electric systems, such as electrical connection to an A/C electricity source, without departing from the invention. The lower part of the power assembly 40 has a foot 44 extending downwardly therefrom. The bottom surface 46 of the foot 44 has a magnet 45 mounted therein for a purpose which will be more fully referred to hereinafter.

The clamp assembly 30 comprises a threaded member 31 threadably mounted on the lower arm 51 through a threaded opening 52 therein. The threaded member 31 has a foot 32 at its lower end having a bottom surface 36 within which a magnet 33 is mounted. The upper part of the threaded member 31 has a striker head 34 which is adapted to strike the underside or anvil 53 of the upper arm 50 when the threaded member 31 is in its fully upward position. It will be seen that when threaded element 31 is threadably moved upwardly to the fully upward position with the striker head 34 in contact with the anvil 53 (FIG. 3), its magnet 33 is on the same plane or level as the magnet 45 mounted below the power assembly 40.

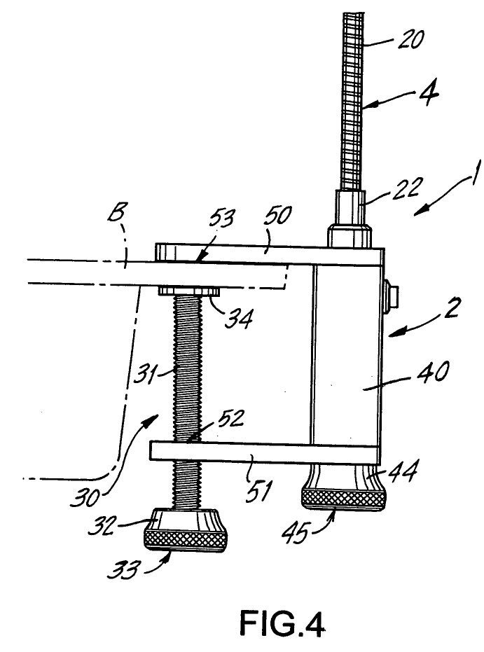

The threaded element 31 is adapted to be screwed downwardly so that an article B, such as a shelf, table or barbeque, may be inserted in the space formed between the striker head 34 and the anvil 53 as shown in FIG. 4. When the threaded element 31 is tightened by moving it upwardly toward the anvil 53, the article B will be clamped between the striker head 34 and the anvil 52 so that the detachable lamp 1 will be held firmly on the article B. To remove the detachable lamp 1 from the article B the threaded member 31 is unscrewed to lower the striker 34 away from the article B which releases the article B. The detachable lamp 1 may be used in this manner regardless of the material from-which the article B is made of.

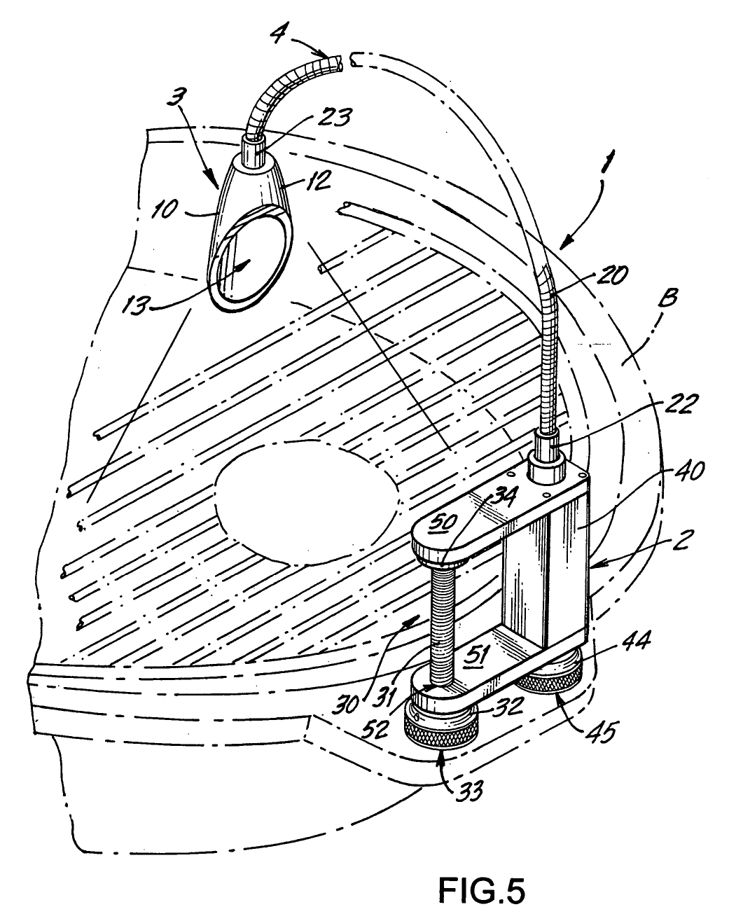

If the article B or a portion thereof, is made of a magnetizable material, such as a metal, it is also possible to attach the detachable lamp 1 to the article B magnetically, as shown in FIG. 5. The threaded element 31 is threadably moved upwardly until the striker head 34 strikes the anvil 53. In this position, the magnet 33 on the foot 32 of the threaded element 31 is at the same level or plane as the magnet 45 on the foot 44 of the power assembly 40. In this position, the detachable lamp 1 can be placed on the metal portion of the article B as shown in FIG. 5, and the magnets 33-45 will magnetically be attracted to the metal of the article B to hold the detachable lamp 1 firmly in place. When it is desired to detach the detachable lamp 1 from the article B it is merely necessary to pull it away from the article B until the magnets 33-45 are no longer magnetically attracted to the article B.

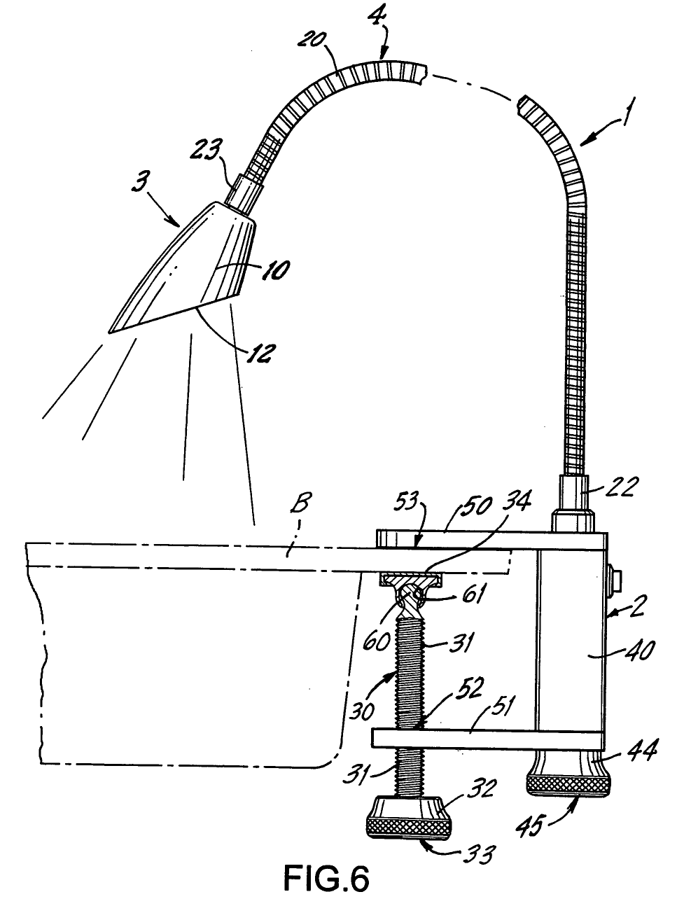

FIG. 6 shows another embodiment of the present invention. Structures in this embodiment which are the same as structures in the FIGS. 1-5 embodiment are identified by the same reference characters. In this embodiment, the striker head 34 of the clamp assembly 30 has a swivel socket 61 mounted on a swivel ball 60 so that the striker head 34 will swivel slightly to accommodate itself to any variations in the surface of the article B on which the detachable lamp 1 is being mounted.

It will thus be seen that the present invention provides a detachable lamp which has improved means for attaching it to an article, which has versatile means for detachably attaching it to a variety of articles such as a shelf, table or barbeque grill and which is simple to use and inexpensive to manufacture.

As many and varied modifications of the subject matter of this invention will become apparent to those skilled in the art from the detailed description given hereinabove, it will be understood that the present invention is limited only as provided in the claims appended hereto.

The embodiments of the invention in which an exclusive property or privilege is claimed are defined as follows:

1. A detachable lamp for attachment to an article comprising an attachment assembly, a bulb assembly and connecting means to connect the attachment assembly to the bulb assembly, said attachment assembly comprising a power assembly to provide electric power to said bulb assembly and a clamp assembly to permit attachment of the lamp to an article.

2. A detachable lamp as set forth in claim 1 wherein said clamp assembly is connected to said power assembly.

3. A detachable lamp as set forth in claim 2 wherein an arm extends from said power assembly and wherein said clamp assembly is mounted on said arm.

4. A detachable lamp as set forth in claim 3 wherein said clamp assembly comprises a threaded member having a striker head.

5. A detachable lamp as set forth in claim 4 wherein at least two arms extend from said power assembly and wherein one of said arms comprises an anvil against which said striker head is adapted to strike.

6. A detachable lamp as set forth in claim 5 wherein said threaded member is mounted on one of said arms and wherein said other arm comprises said anvil.

7. A detachable lamp as set forth in claim 6 wherein said striker head is swivally mounted on said threaded member.

8. A detachable lamp as set forth in claim 6 wherein magnetic means are mounted on said attachment assembly.

9. A detachable lamp as set forth in claim 8 wherein said magnetic means comprises magnetic means mounted on said power assembly.

10. A detachable lamp as set forth in claim 9 wherein said magnetic means comprises magnetic means mounted on said clamp assembly.

11. A detachable lamp as set forth in claim 10 wherein a foot depends from said clamp assembly and wherein a magnet is mounted on said foot.

12. A detachable lamp as set forth in claim 11 wherein a foot depends from said power assembly and wherein a magnet is mounted on said foot.

13. A detachable lamp as set forth in claim 12 wherein the magnet on the foot of the clamp assembly and the magnet on the foot of the power assembly are on the same plane or level when said striker head strikes said anvil.

14. A detachable lamp as set forth in claim 13 wherein said connecting means comprises a flexible goose-neck connector having electrical conducting wire therewithin to electrically connect said bulb assembly to said power assembly.

15. A detachable lamp as set forth in claim 1 wherein magnetic means are-mounted on said attachment assembly.

16. A detachable lamp as set forth in claim 15 wherein said magnetic means comprises magnetic means mounted on said power assembly.

17. A detachable lamp as set forth in claim 16 wherein said magnetic means comprises magnetic means mounted on said clamp assembly.

18. A detachable lamp as set forth in claim 17 wherein a foot depends from said clamp assembly and wherein a magnet is mounted on said foot.

19. A detachable lamp as set forth in claim 18 wherein a foot depends from said power assembly and wherein a magnet is mounted on said foot.

20. A detachable lamp as set forth in claim 19 wherein the magnet on the foot of the clamp assembly and the magnet on the foot of the power assembly are on the same plane or level when said striker head strikes said anvil
